(19) United States
(12) Patent Application Publication
(10) Pub. No.: US 2024/0062243 A1
(43) Pub. Date: Feb. 22, 2024

(54) METHOD, COMPUTER DEVICE, AND NON-TRANSITORY COMPUTER-READABLE RECORDING MEDIUM FOR PROCESSING INFORMATION AS TEMPORARY MESSAGE

(71) Applicant: NAVER CORPORATION, Seongnam-si (KR)

(72) Inventors: Yu-Kyung SEO, Seongnam-si (KR); Songi KU, Seongnam-si (KR); Gayoung AHN, Seongnam-si (KR); Hyerim OH, Seongnam-si (KR); Dongseop LIM, Seongnam-si (KR); Hyundo RYU, Seongnam-si (KR); Changkyu AHN, Seongnam-si (KR); Kyung Hee YOON, Seongnam-si (KR); Chan Hye PARK, Seongnam-si (KR); JeongMoon HEO, Seongnam-si (KR)

(21) Appl. No.: 18/452,140

(22) Filed: Aug. 18, 2023

(30) Foreign Application Priority Data
Aug. 18, 2022 (KR) 10-2022-0103625

(51) Int. Cl. G06Q 30/0251

(52) U.S. Cl. CPC G06Q 30/0257

(57) ABSTRACT

A temporary message processing method includes, in response to an entry request from a user for entry into a chatroom, verifying whether the user has consented to receiving marketing information from a business operator related to the chatroom; and when the user has not consented to receiving marketing information, configuring a marketing message of the business operator in a form of a volatile temporary message and displaying the same in the chatroom.

### CROSS-REFERENCE TO RELATED APPLICATION(S)

This U.S. non-provisional application claims the benefit of priority under 35 U.S.C. § 119 to Korean Patent Application No. 10-2022-0103625 filed on Aug. 18, 2022, in the Korean Intellectual Property Office (KIPO), the entire contents of which are incorporated herein by reference.

### BACKGROUND OF THE INVENTION

### Field of Invention

One or more example embodiments of the present invention in the following description relate to technology for providing marketing information.

### Description of Related Art

Methods for exchanging messages between devices may be largely classified into a pull method and a push method.

The pull method refers to a method in which a device frequently verifies and retrieves information from an information provider and updates data through polling in the foreground and the background of a smartphone.

In contrast, the push method refers to a method in which a publisher or a server forcibly delivers information to a device, and an operating system (OS) maintains a continuous connection state with a push support service and a server side delivers a message to a smartphone.

For example, a technique for providing advertising video data using a push method is described in Korean Patent Registration No. 10-0408597, registered on Nov. 25, 2003.

In general, marketing information may be provided as a push message to a user who has consented to receiving marketing information through receiving news or adding friends.

### BRIEF SUMMARY OF THE INVENTION

One or more example embodiments may display marketing information through a dedicated message template for those who have not consented to receiving marketing information.

One or more example embodiments may provide marketing information as a message of a temporary display method rather than a message reception method.

According to an aspect of at least one example embodiment, there is provided a temporary message processing method performed by a computer device including at least one processor configured to execute computer-readable instructions included in a memory, the method including, by the at least one processor, in response to an entry request from a user for entry into a chatroom, verifying whether the user is a user who has consented to receiving marketing information from a business operator related to the chatroom; and when the user corresponds to a user who has not consented to receiving marketing information, configuring a marketing message of the business operator in a form of a volatile temporary message and displaying the same in the chatroom.

The displaying of the volatile temporary message may include retrieving information on the marketing message from a separate message box related to the business operator and configuring the information in the temporary message form, in the case of the user who has not consented to receiving marketing information.

The displaying may include processing the marketing message as a message that does not accumulate in a personal message inbox of the user in the case of the user who has not consented to receiving marketing information.

The displaying may include not displaying a conversation interface that includes a message input box and a consultation banner that includes information related to consultation with the business operator in the chatroom in the case of the user who has not consented to receiving marketing information.

The displaying may include configuring the marketing message in a message form that includes at least one function of share, delete, forward, and reply.

The temporary message processing method may further include, by the at least one processor, volatilizing the marketing message according to a user action and deleting the marketing message from the chatroom.

The temporary message processing method may further include, by the at least one processor, processing the marketing message as a received message according to a user action and converting the same to a message type that is saved as a history of the chatroom.

The displaying may include verifying message redundancy by comparing the marketing message and a received message stored in a personal message inbox of the user; and when the marketing message is duplicated with the received message, displaying the received message of the same contents without configuring the marketing message in the temporary message form.

The displaying may include receiving the entry request through a link of the marketing message displayed on a service screen related to the business operator.

The temporary message processing method may further include, by the at least one processor, when the user corresponds to a user who has consented to receiving marketing information, configuring the marketing message in a form of a received message and displaying the same in the chatroom.

According to an aspect of at least one example embodiment, there is provided a non-transitory computer-readable recording medium storing a computer program to implement the temporary message processing method in the computer device.

According to an aspect of at least one example embodiment, there is provided a computer device including at least one processor configured to execute computer-readable instructions included in a memory. The at least one processor is configured to, in response to an entry request from a user for entry into a chatroom, verify whether the user is a user who has consented to receiving marketing information from a business operator related to the chatroom, and when the user corresponds to a user who has not consented to receiving marketing information, configure a marketing message of the business operator in a form of a volatile temporary message and displaying the same in the chatroom.

According to some example embodiments, it is possible to expand reception of marketing information and to support viewing of more information by displaying marketing information through a dedicated message template for those who have not consented to receiving marketing information.

According to some example embodiments, it is possible to reduce indiscriminate information accumulation and marketing fatigue by providing marketing information in a form of a volatile message of a temporary display method rather than a message reception method that is saved as a history.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram illustrating an example of a network environment according to at least one example embodiment;

FIG. 2 is a diagram illustrating an example of a computer device according to at least one example embodiment;

FIG. 3 is a flowchart illustrating an example of a temporary message processing method performed by a computer device according to at least one example embodiment;

FIGS. 4 and 5 illustrate examples of a temporary message form and a permanent message form according to at least one example embodiment;

FIG. 6 illustrates an example of a service screen on which a marketing message is displayed according to at least one example embodiment;

FIGS. 7 and 8 illustrate examples of a process of displaying a temporary message according to at least one example embodiment; and

FIGS. 9 and 10 illustrate examples of a process of processing a temporary message according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element, there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flowcharts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments of the present invention will be described with reference to the accompanying drawings.

The example embodiments relate to technology for providing marketing information.

The example embodiments set forth herein may provide marketing information to those who have not consented to receiving marketing information in a form of a volatile message of a temporary display method, rather than a message reception method.

A temporary message processing system according to the example embodiments may be implemented by at least one computer device and a temporary message processing method according to the example embodiments may be performed by the at least one computer device included in the temporary message processing system. Here, a computer program according to an example embodiment may be installed and executed on the computer device, and the computer device may perform the temporary message processing method according to the example embodiments under the control of the executed computer program. The aforementioned computer program may be stored in a computer-readable storage medium to computer-implement the temporary message processing method in conjunction with the computer device.

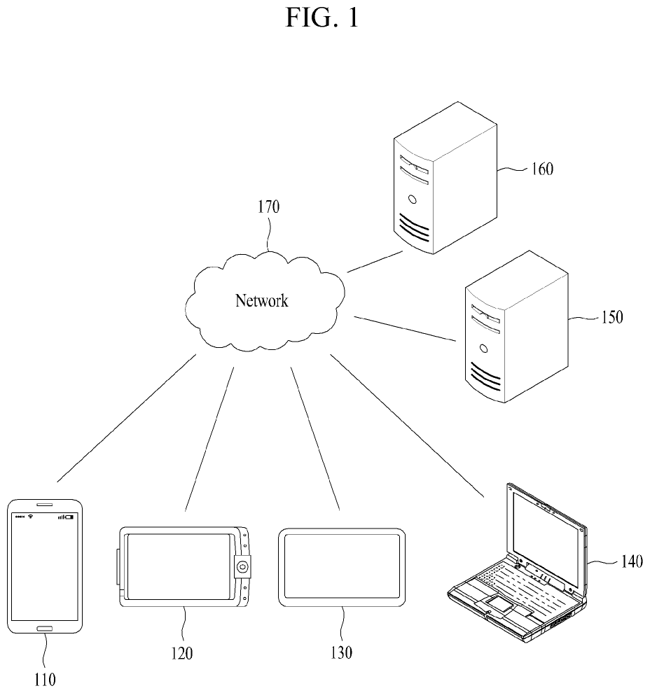

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. A number of electronic devices or a number of servers is not limited thereto. Also, the network environment of FIG. 1 is provided as an example among environments applicable to the example embodiments and the environment applicable to the example embodiments is not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet personal computer (PC), and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner. The communication scheme is not limited and may include a near field wireless communication scheme between devices as well as a communication scheme using a communication network (e.g., a mobile communication network, wired Internet, wireless Internet, a broadcasting network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service, for example, a chat service, to the plurality of electronic devices 110, 120, 130, and 140 connected over the network 170.

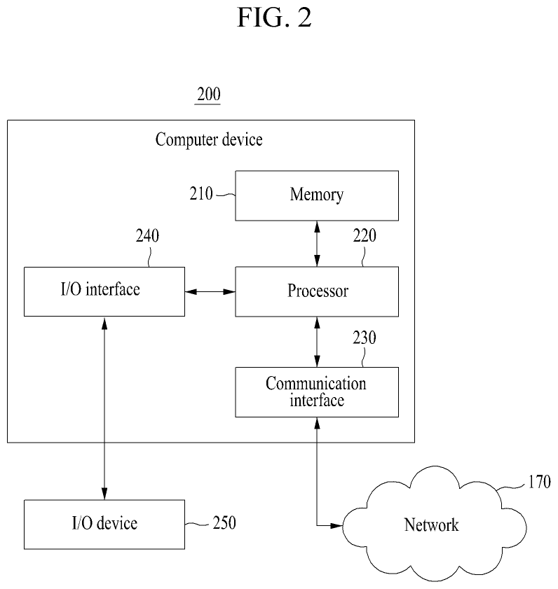

FIG. 2 is a block diagram illustrating an example of a computer device according to at least one example embodiment. Each of the plurality of electronic devices 110, 120, 130, and 140 or each of the servers 150 and 160 described above may be implemented by a computer device 200 of FIG. 2. For example, a temporary message processing system according to example embodiments may be implemented by the computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable record medium. The permanent mass storage device, such as ROM and a disk drive, may be included in the computer device 200 as a permanent storage device separate from the memory 210. Also, an OS and at least one program code may be stored in the memory 210. Such software components may be loaded to the memory 210 from another non-transitory computer-readable record medium separate from the memory 210. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 210 through the communication interface 230, instead of the non-transitory computer-readable record medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the communication apparatus 200 and another apparatus, for example, the aforementioned storage devices, over the network 170. For example, the processor 220 of the computer device 200 may transmit a request or an instruction created based on a program code stored in the storage device such as the memory 210, data, and a file, to other apparatuses over the network 170 under the control of the communication interface 230. Inversely, a signal, an instruction, data, a file, etc., from another apparatus may be received at the computer device 200 through the communication interface 230 of the computer device 200 over the network 170. For example, a signal, an instruction, content, data, etc., received through the communication interface 230 may be transmitted to the processor 220 or the memory 210, and a file, etc., may be stored in a storage medium, for example, the permanent storage device, further includable in the computer device 200.

The I/O interface 240 may be a device used for interfacing with an I/O device 250. For example, an input device of the I/O device 250 may include a device, such as a microphone, a keyboard, a mouse, etc., and an output device of the I/O device 250 may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

According to other example embodiments, the computer device 200 may include greater or less number of components than those shown in FIG. 2. For example, the computer device 200 may include at least a portion of the I/O device 250, or may further include other components, for example, a transceiver, a database, etc.

Hereinafter, example embodiments of a method and apparatus for processing marketing information as a temporary message are described.

Herein, a chat service provides a communication service between a business operator and a customer (user) and may be used as a tool for one-to-one consultation with a business operator on a user side and may be used as a marketing tool for users on a business operator side.

Example embodiments may enhance a function of a marketing method such that a business operator may transmit marketing information to more users without the hurdles of collecting consent to receive marketing information and such that the user may discover information with good quality although the user has not consented to receiving marketing information.

Marketing information may include a marketing message that a business operator whose store (shopping mall) is located on a shopping platform on the server 150 or a business operator whose offline business information is displayed through a map service linked to the server 150 desires to deliver; a marketing message that an external business operator desires to deliver through a chat API; and a marketing message to be delivered in an internal service on the server 150, with respect to a customer.

The computer device 200 according to the example embodiment may provide a client with a chat service through access to a dedicated application installed on the client or a website/mobile site related to the computer device 200. A temporary message processing system implemented as a computer may be configured in the computer device 200. For example, the temporary message processing system may be configured in a form of a program that independently operates or may be configured in an in-app form of a specific application to be operable on the specific application.

The processor 220 of the computer device 200 may be implemented as a component for performing the following temporary message processing method. Depending on example embodiments, components of the processor 220 may be selectively included in or excluded from the processor 220. Also, depending on example embodiments, components of the processor 220 may be separated or merged for functional representation of the processor 220.

The processor 220 and the components of the processor 220 may control the computer device 200 to perform operations included in the following temporary message processing method. For example, the processor 220 and the components of the processor 220 may be implemented to execute instructions according to a code of at least one program and a code of an OS included in the memory 210.

Here, the components of the processor 220 may be representations of different functions performed by the processor 220 in response to instructions provided from a program code stored in the computer device 200.

The processor 220 may read necessary instructions from the memory 210 to which instructions related to control of the computer device 200 are loaded. In this case, the read instructions may include instructions for controlling the processor 220 to execute the following operations.

Operations included in the following temporary message processing method may be performed in order different from the illustrated order. A portion of operations may be omitted or an additional process may be further included.

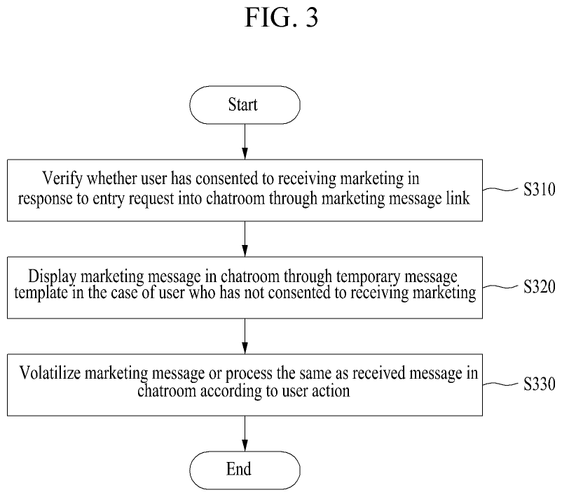

FIG. 3 is a flowchart illustrating an example of a temporary message processing method performed by a computer device according to at least one example embodiment.

The temporary message processing method according to the example embodiment may be performed by the aforementioned computer device 200. In this case, the processor 220 of the computer device 200 may be implemented to execute control instruction according to a code of at least one program or a code of an OS included in the memory 210. Here, the processor 220 may control the computer device 200 such that the computer device 200 may perform operations S310 to S330 included in the temporary message processing method of FIG. 3 according to control instructions provided from a code stored in the computer device 200.

Referring to FIG. 3, in operation S310, the processor 220 may verify whether a user has consented to receiving marketing information in response to an entry request into a chatroom through a marketing message link. A marketing message may be displayed through various types of service screens related to a shopping platform, such as a goods detail page, a goods search page, and a goods benefit page, and may be commonly displayed for all the users accessible to a service screen regardless of whether reception of marketing information is consented to. The processor 220 may receive a chatroom entry request through a marketing message link that is displayed on various service screens. The marketing message may be managed through a message ID and the message ID may be managed in association with a business operator ID for identifying a business operator corresponding to the marketing message. When the user clicks on the marketing message displayed through various service screens, the processor 220 may verify a business operator ID through a message ID, and then verify whether the user has consented to receiving marketing information of the corresponding business operator.

In operation S320, in response to the entry request into the chatroom, the processor 220 may enter into a one-to-one chatroom between the user and the business operator. Here, when the user corresponds to a user who has not consented to receiving marketing information, the processor 220 may display the marketing message in a temporary message form in the chatroom with the business operator. When the user who has not consented to receiving marketing information enters the chatroom with the business operator through the marketing message link, the processor 220 may display the corresponding marketing message using a temporary message template that is a dedicated message template for the user who has not consented to receiving marketing information. The temporary message template represents a form of a volatile message of a temporary display method and may have at least one interface distinguished from a received-message-only template that is a permanent message form saved as a conversation history of the chatroom. When the user corresponds to the user who has not consented to receiving marketing information at a time of entering the chatroom with the business operator, the processor 220 may display the marketing message through the temporary message template. When the user corresponds to the user who has consented to receiving marketing information, the processor 220 may display the marketing message through the permanent message template. When the user enters the chatroom, the processor 220 may acquire and configure information on the temporary message from a separate system, for example, a message box of the business operator, not a personal message inbox of the user, and may display the temporary message in a message form with a personal received message in a process of configuring information to be displayed in the chatroom.

In operation S330, the processor 220 may volatilize the marketing message displayed as the temporary message or may process the marketing message as the received message in a permanent message form in the chatroom of the business operator according to a user action of the user that corresponds to the user who has not consented to receiving marketing information. For example, when the user leaves a corresponding chatroom without an additional action, such as sending or sharing a message in the chatroom, after the marketing message is displayed, the processor 220 may delete the marketing message from the chatroom through volatilization. That is, in the case of the user who has not consented to receiving marketing, the marketing message is displayed to be one-off in the chatroom according to a temporary display method and when the user leaves the chatroom, the marketing message disappears from the chatroom. As another example, when the user consents to receiving marketing information or performs an additional action, such as sending or sharing a message, through the chatroom after the marketing message is displayed, the processor 220 may process the marketing message displayed as the temporary message, as the received message. Processing as the received message may represent converting the marketing message from a volatile temporary message type to a permanent message type that is saved as a conversation history of the chatroom.

Therefore, when the user who has not consented to receiving marketing information enters the chatroom with the business operator through the marketing message link through various service screens, the processor 220 may display the corresponding marketing message in a form of the volatile message of the temporary display method rather than a message reception method.

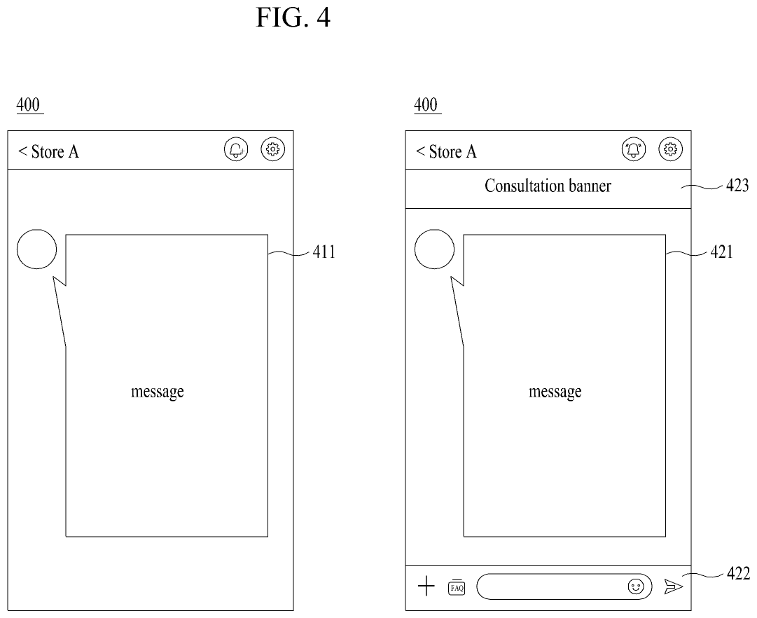

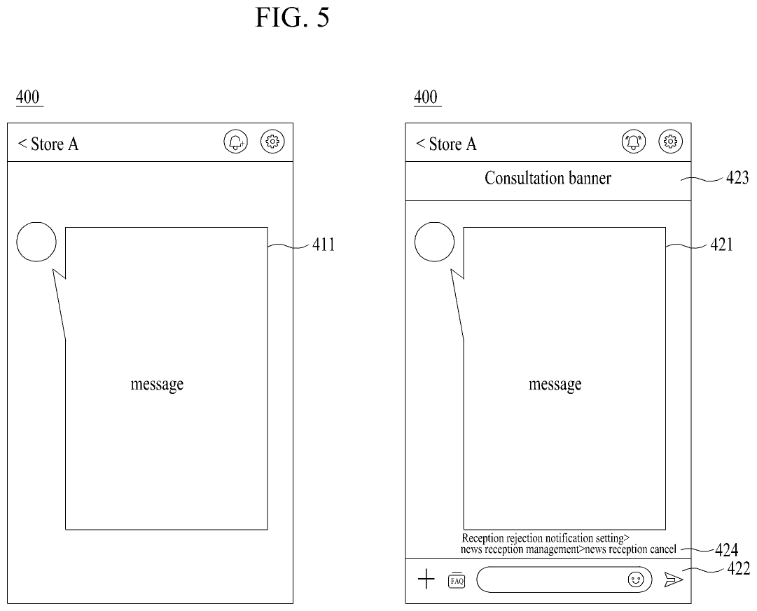

FIGS. 4 and 5 illustrate examples of a temporary message form and a permanent message form according to at least one example embodiment.

Referring to FIG. 4, a marketing message may be displayed in a temporary message form 411 in a chatroom 400 for those who have not consented to receiving marketing information and the marketing message may be displayed in a permanent message form 421 in the chatroom 400 for those who have consented to receiving marketing information.

The temporary message form 411 and the permanent message form 421 may be configured as a message template that includes contents of the marketing message.

In the temporary message form 411 and the permanent message form 421, functions associated with conversational messages may be similarly implemented. For example, in addition to an operation of a button link included in message contents, functions that may be implemented for a received message, such as message share, message delete, message forward, and message reply, may be applied to a temporary message.

In the temporary message form 411 and the permanent message form 421, some display elements may be differently displayed. For example, the temporary message form 411 and the permanent message form 421 may be distinguished by using different shapes or colors of message speech bubbles and highlights.

The chatroom 400 in a state in which reception of marketing information is consented to may include a conversation interface 422 that includes a message input box for real-time conversation (chat) and a consultation banner 423 that includes information related to consultation with a business operator since connection is set between the user and the business operator.

The chatroom 400 in a state in which reception of marketing information is not consented to may not display the conversation interface 422 and the consultation banner 423 since the connection is not set between the user and the business operator.

Functions of the chatroom 400 may be diverged based on distinction between the temporary message form 411 and the permanent message form 421, depending on whether reception of marketing information is consented to. An operation distinct from a received message may be applied to a temporary message.

For example, in the case of the marketing message, regarding policy obligation to display a reception rejection method in a chatroom, a reception rejection interface 424 for setting reception rejection may be displayed in the chatroom 400 for those who have consented to receiving marketing information since a permanent message processed as a received message is displayed. On the other hand, the reception rejection interface 424 may be omitted in the chatroom 400 for those who have not consented to receiving marketing information since not an actual received message but a volatile temporary message is displayed for one time.

Due to a temporary message template that is distinguished from a received message template, marketing messages may be commonly displayed on various service screens for marketing targets that include those who have not consented to receiving marketing information.

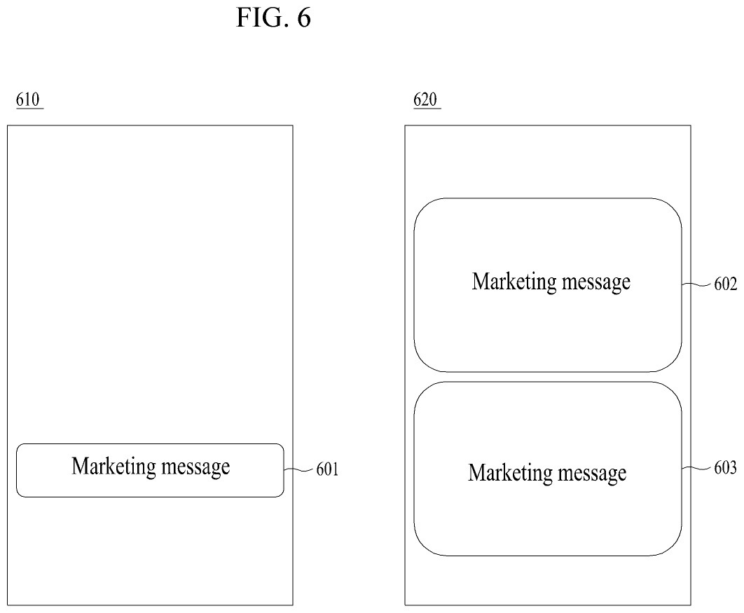

FIG. 6 illustrates an example of a service screen on which a marketing message is displayed according to at least one example embodiment.

Referring to FIG. 6, a marketing message 601, 602, 603 of a corresponding business operator may be displayed through various service screens on which goods of the business operator are displayed, such as a goods detail page 610 for providing detailed information on specific goods of the business operator, a goods search page 620 for searching for goods on a shopping platform, and a goods benefit page (not shown) for providing benefit information related to goods on the shopping platform.

The marketing messages 601, 602, and 603 may be commonly displayed regardless of whether the user has consented to receiving marketing information.

The marketing messages 601, 602, and 603 displayed on service screens, such as the goods detail page 610 and the goods search page 620, include links to corresponding messages. Here, only at least a portion of the entire message contents may be displayed.

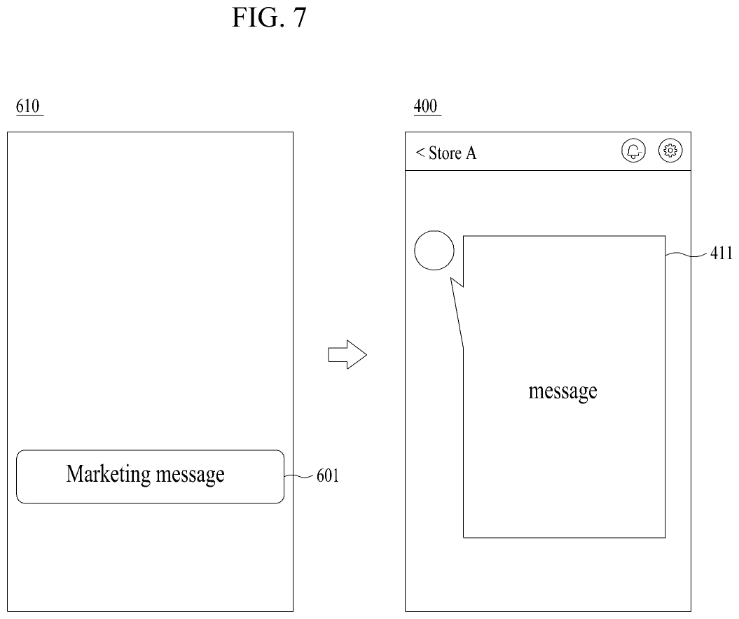

FIGS. 7 to 10 illustrate examples of a temporary message processing process according to at least one example embodiment.

Referring to FIG. 7, when a user who has not consented to receiving marketing information of store A selects the marketing message 601 of the store A on the goods detail page 610, the processor 220 may enter the chatroom 400 between the user and the store A and may display contents of the marketing message 601 in the temporary message form 411 through the chatroom 400.

When the user enters the chatroom 400 through a link of the marketing message 601 in a state in which reception of marketing information is not consented to, the processor 220 may retrieve contents of the marketing message 601 from a separate system rather than a personal message inbox of the user and may display the same in the temporary message form 411.

Although the user has not consented to receiving marketing information, a marketing message of the store A processed as a received message may be present. Here, the processor 220 may retrieve the received message stored in the personal message inbox and may display a temporary message with the personal received message.

The processor 220 may provide a service such that even a user who has not consented to receiving marketing information of a business operator may view the marketing message 601 through temporary message processing.

Since contents of the marketing message 601 to be displayed in the temporary message form 411 may be the same as contents of a message that is already received, message redundancy may be verified by comparing the contents of the marketing message 601 to the received message stored in the personal message inbox. When the contents of the marketing message 601 overlap with those of the already received message, a message configuration to the temporary message form 411 may be suspended and the received message having the same contents among messages included in the chatroom 400 may be scrolled and displayed.

Through this, it is possible to prevent the same message from being redundantly displayed as the received message and the temporary message.

In a state in which reception of marketing information is not consented to, the conversation interface 422, the consultation banner 423, and the reception rejection interface 424 may be omitted from the chatroom 400.

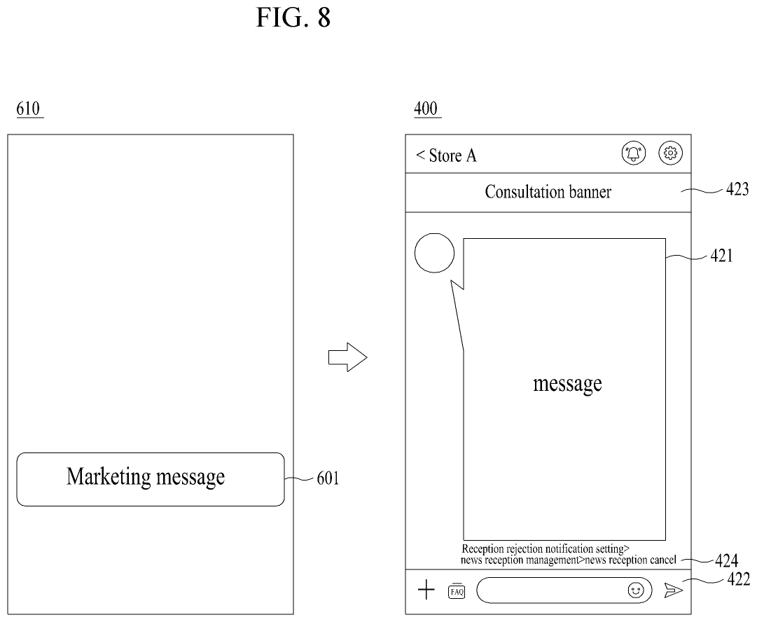

Referring to FIG. 8, when the user who has consented to receiving marketing information of the store A selects the marketing message 601 of the store A on the goods detail page 610, the processor 220 may display contents of the marketing message 601 in the permanent message form 421 through the chatroom 400 between the user and the store A.

When the user enters the chatroom 400 through the link of the marketing message 601 in a state in which reception of marketing information is consented to, the processor 220 may retrieve the contents of the marketing message 601 from the personal message inbox of the user and may display the same in the permanent message form 421. Here, the conversation interface 422, the consultation banner 423, and the reception rejection interface 424 may be activated and displayed in the chatroom 400.

The processor 220 may volatilize the marketing message 601 to the temporary message form 411 or may process the same as a received message according to a user action in a state in which reception of marketing information is not consented to.

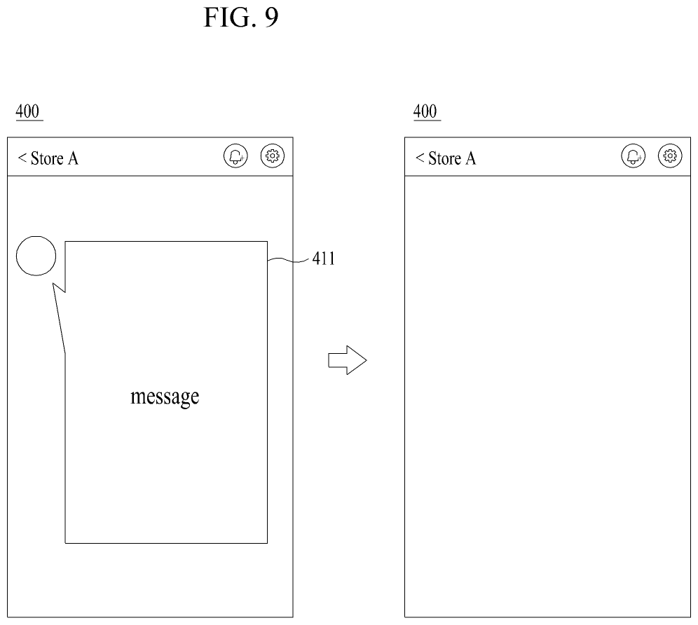

Referring to FIG. 9, when the user leaves the corresponding chatroom 400 by entering another chatroom or leaving the chatroom 400 after the marketing message 601 is displayed in the temporary message form 411 in the chatroom 400, the processor 220 may volatilize the marketing message 601 displayed in the temporary message form 411.

The marketing message 601 processed as the temporary message refers to a message that does not accumulate in the personal message inbox of the user and may disappear from the chatroom 400 without being saved as a conversation history between the user and the business operator.

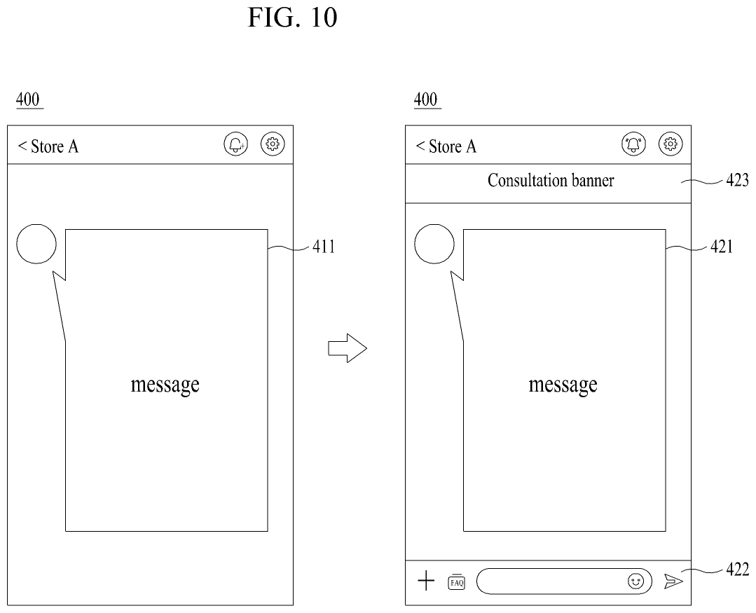

Referring to FIG. 10, when the user consents to receiving marketing information of the store A or performs an additional action, such as sending or sharing a message, in the chatroom 400 after the marketing message 601 is displayed in the temporary message form 411 in the chatroom 400, the processor 220 may process the marketing message 601 displayed in the temporary message form 411 as the received message.

The marketing message 601 processed as the received message refers to a message that accumulates in the personal message inbox of the user and may be saved as conversation history between the user and the business operator and remain as a permanent message in the chatroom 400.

As describe above, according to some example embodiments, it is possible to expand reception of marketing information and to support viewing of more information by displaying marketing information through a dedicated message template for those who have not consented to receiving marketing information. Also, according to some example embodiments, it is possible to reduce indiscriminate information accumulation and marketing fatigue by providing marketing information in a form of a volatile message of a temporary display method rather than a message reception method that is saved as a history.

The apparatuses described herein may be implemented using hardware components, software components, and/or a combination thereof. For example, the apparatuses and the components described herein may be implemented using one or more computers or processing devices, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, a processing device may include multiple processors or a processor and a controller. In addition, different processing configurations are possible, such as parallel processors.

The software may include a computer program, a piece of code, instructions, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable media including program instructions to implement various operations embodied by a computer. The media may also include, alone or in combination with the program instructions, data files, data structures, and the like. The media may continuously store computer-executable programs or may transitorily store the same for execution or download. Also, the media may be various types of recording devices or storage devices in a form in which one or a plurality of hardware components are combined. Without being limited to a media directly connected to a computer system, the media may be distributed over the network. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software. Examples of program instructions include both machine code, such as produced by a compiler, and files containing higher level code that may be executed by the computer using an interpreter.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A temporary message processing method performed by a computer device comprising at least one processor configured to execute computer-readable instructions included in a memory, the method comprising:
in response to an entry request from a user for entry into a chatroom, verifying whether the user has consented to receiving marketing information from a business operator related to the chatroom; and
when the user has not consented to receiving marketing information, configuring a marketing message of the business operator in a form of a volatile temporary message and displaying the volatile temporary message in the chatroom.

2. The method of claim 1, wherein the displaying of the volatile temporary message comprises retrieving information on the marketing message from a separate message box related to the business operator and configuring the information in the form of the volatile temporary message.

3. The method of claim 1, wherein the displaying of the volatile temporary message comprises processing the marketing message as a message that does not accumulate in a personal message inbox of the user.

4. The method of claim 1, wherein the displaying of the volatile temporary message comprises not displaying a conversation interface that includes a message input box and a consultation banner that includes information related to consultation with the business operator in the chatroom.

5. The method of claim 1, wherein the displaying of the volatile temporary message comprises configuring the marketing message in a message form that includes at least one function of share, delete, forward, and reply.

6. The method of claim 1, further comprising:
volatilizing the volatile temporary message according to a user action and deleting the volatile temporary message from the chatroom.

7. The method of claim 1, further comprising:
processing the marketing message as a received message according to a user action and converting the received message to a message type that is saved as a history of the chatroom.

8. The method of claim 1, wherein the displaying of the volatile temporary message comprises:
verifying message redundancy by comparing the marketing message and a received message stored in a personal message inbox of the user; and
when the marketing message is duplicated with the received message, displaying the received message without configuring the marketing message in the form of the volatile temporary message.

9. The method of claim 1, wherein the displaying of the volatile temporary message comprises receiving the entry request through a link of the marketing message displayed on a service screen related to the business operator.

10. The method of claim 1, further comprising:
when the user has consented to receiving marketing information, configuring the marketing message in a form of a received message and displaying the received message in the chatroom.

11. A non-transitory computer-readable recording medium storing a computer program for causing a computer device to implement the temporary message processing method of claim 1.

12. A computer device comprising:
at least one processor configured to execute computer-readable instructions recorded in a memory,
wherein the at least one processor is configured to, in response to an entry request from a user for entry into a chatroom, verify whether the user has consented to receiving marketing information from a business operator related to the chatroom, and to, when the user has not consented to receiving marketing information, configure a marketing message of the business operator in a form of a volatile temporary message and displaying the volatile temporary message in the chatroom.

13. The computer device of claim 12, wherein the at least one processor is configured to retrieve information on the marketing message from a separate message box related to the business operator and to configure the information in the form of the volatile temporary message, in the case the user has not consented to receiving marketing information.

14. The computer device of claim 12, wherein the at least one processor is configured to process the marketing message as a message that does not accumulate in a personal message inbox of the user in the case the user has not consented to receiving marketing information.

15. The computer device of claim 12, wherein the at least one processor is configured to not display a conversation interface that includes a message input box and a consultation banner that includes information related to consultation with the business operator in the chatroom in the case the user has not consented to receiving marketing information.

16. The computer device of claim 12, wherein the marketing message is configured in a message form that includes at least one function of share, delete, forward, and reply.

17. The computer device of claim 12, wherein the at least one processor is configured to volatilize the volatile temporary message according to a user action and to delete the volatile temporary message from the chatroom.

18. The computer device of claim 12, wherein the at least one processor is configured to process the volatile temporary message as a received message according to a user action and to convert the volatile temporary message to a message type that is saved as a history of the chatroom.

19. The computer device of claim 12, wherein the at least one processor is configured to verify message redundancy by comparing the marketing message and a received message stored in a personal message inbox of the user, and to, when the marketing message is duplicated with the received message, display the received message without configuring the marketing message in the form of the volatile temporary message.

20. The computer device of claim 12, wherein the at least one processor is configured to receive the entry request through a link of the marketing message displayed on a service screen related to the business operator.
